(19) United States
(12) Patent Application Publication
(10) Pub. No.: US 2006/0213313 A1
(43) Pub. Date: Sep. 28, 2006

(54) Hand brake blocker

(76) Inventor: David Macias, Mascouche (CA)

Correspondence Address: INVENTARIUM, Suite 1607, 4050 Rosemont blvd, Montreal, QC, H1X 1M4, CA

(21) Appl. No.: 11/386,349

(22) Filed: Mar. 22, 2006

Related U.S. Application Data
(60) Provisional application No. 60/663,685, filed on Mar. 22, 2005.

(51) Int. Cl. G05G 1/04

(52) U.S. Cl. 74/526

(57) ABSTRACT

A hand brake blocker which uses a locking means which blocks the rod that disengages the lever of the hand brake. The hand brake lever not being able to disengage, the wheels remian in parked mode.

This application claims priority based on provisional application 60/663,685 filed Mar. 22, 2005

### BACKGROUND OF THE INVENTION

1. Field of the Invention

The invention relates generally to locking or anti-theft devices but more particularly to a lockable device that blocks a hand brake into braking position.

2. Background of the Invention

Using a vehicle's hand brake as an anti theft device is not new and dates back to the early history of the automobile industry. The prior art reveals some very basic means for locking a hand brake as well as some very elaborate means making use of computer electronics or involving the locking of gas or brake pedals or even the stick shift.

### SUMMARY OF THE INVENTION

This invention describes a hand brake blocker which which blocks the rod that disengages the lever of the hand brake. The hand brake lever not being able to disengage, the wheels remian in parked mode.

### BRIEF DESCRIPTION OF THE PREFERRED EMBODIMENT

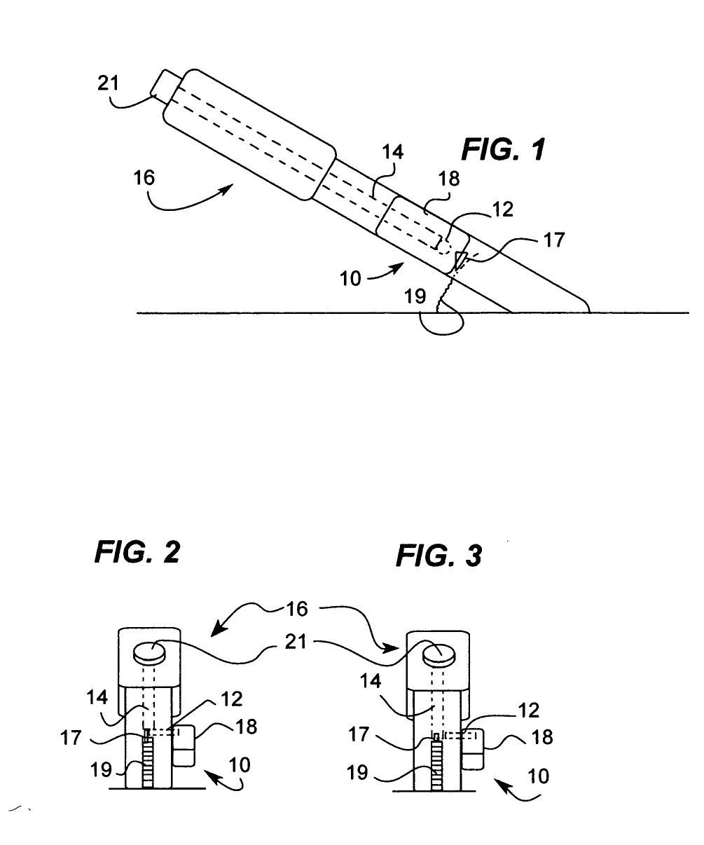

FIG. 1 Side view of a hand brake with the blocker means.

FIG. 2 Front view of a hand brake with the blocker means engaged.

FIG. 3 Front view of a hand brake with the blocker means disengaged.

### DETAILED DESCRIPTION OF THE PREFERRED EMBODIMENT

A hand brake blocker means (10) uses a locking pin (12) which which blocks a rod (14) that is usually found in existing hand brakes (16) and which is used to disengage the hand brake (16) from its braking configuration by moving a pawl (17) away from ratcheted teeth (19), that part being known in the art. What is novel here is how the rod (14) is blocked. The prior art shows combination locks blocking a push button (21) but in this case, it is the rod (14) that is blocked by a locking pin (12) which moves in and out of a casing (18) so as to free or block the rod (14). The locking pin (12) can be actuated by any one of a variety of actuating means well known in the art such as electrically, hydraulically or pneumatically actuated lead screw or solenoid or any such known means. The casing (18) is sturdy enough to resist force from a thief who would try to disable the brake blocker means (10).

The actuation of the hand brake blocker means (10) occurs after the hand brake (16) is raised into the brake blocking configuration and the car doors are locked. The user does not have any other action to do than to engage or disengage the hand brake (16) and to lock or unlock the car door in order for the hand brake blocker means (10) to operate as long as the door locking and unlocking is done by way of the car key itself or its associated remote door opener. A thief could not, for example, break the window, unlock the door from inside and automatically disengage the hand brake blocker means (10), that would be too easy!

All manners of electronic controls are well known in the art, in fact, the actuating means for the locking pin (12) could in fact be very similar to the actuating means used for locking and unlocking car doors.

1. A hand brake blocker means comprising:
a locking pin to block a rod so as to stop it from moving a pawl away from ratcheted teeth;
said locking pin moving in and out of a casing so as to free or block said rod;
said locking pin being actuated by actuating means.

2. A hand brake blocker means as in claim 1 having the following method of use:
said hand brake blocker means being actuated after said hand brake is raised into a brake blocking configuration and car doors are locked;
unlocking car doors disengages said locking pin from said rod.
